(19) United States
(12) Patent Application Publication
(10) Pub. No.: US 2025/0214826 A1
(43) Pub. Date: Jul. 3, 2025

(54) CARBONATED WATER METERING SYSTEM FOR BEVERAGE MACHINE

(71) Applicant: LAVAZZA PROFESSIONAL NORTH AMERICA LLC, West Chester, PA (US)

(72) Inventor: Michael GARLAND, Chineham (GB)

(21) Appl. No.: 18/844,973

(22) PCT Filed: Mar. 8, 2023
(86) PCT No.: PCT/US2023/014797

§ 371 Date: Sep. 8, 2024

Related U.S. Application Data
(60) Provisional application No. 63/317,901, filed on Mar. 8, 2022.

(51) Int. Cl. B67D 1/00; B67D 1/08

(52) U.S. Cl. CPC B67D 1/0075; B67D 1/0022; B67D 1/0062; B67D 1/0888

(57) ABSTRACT

A programmable carbonated beverage preparation system and related method of use. The system includes a gas source containing carbon dioxide fluidly coupled to a carbonation chamber. The chamber holds an inventory of chilled water with its level controlled by a level sensor and pump fluidly coupled to a water source through a cold block in one embodiment. The chamber may be formed within the cold block which includes parallel coolant and chilled water passageways for chilling water from the water source. A regulator reduces gas pressure from the source which then partially fills the chamber. When a user selects a beverage size via the controller, the system dispenses carbonated water until a preprogrammed setpoint pressure ratio is reach which is indicative of a volume of carbonated water dispensed corresponding to the selected beverage size. Initial moles of gas in the chamber need not be known for performing the process.

### CROSS-REFERENCE TO RELATED APPLICATIONS

The present application claims the benefit of priority to U.S. Provisional Patent Application No. 63/317,901 filed Mar. 8, 2022; the entirety of which is incorporate herein by reference.

### FIELD OF THE INVENTION

The present invention relates to beverage machines for dispensing chilled carbonated beverages, and more particularly to a carbonation system for chilling, dispensing, and metering carbonated water used in the preparation of such beverages.

### BACKGROUND OF THE INVENTION

Carbonated water is produced in commercial carbonated beverage machines or dispensers by mixing carbon dioxide (CO2) with cold water under pressure, and so dissolving some of the CO2 into the water. When a dispense valve is opened at the outlet of the carbonation chamber, the gas pressure forces the carbonated water through the dispensing tube and out of the system. Various flavorants such as in liquid, syrup, or powder form may then mixed with the carbonated water by the machine to prepare a host of different type beverages.

Low cost metering of water is typically achieved using a flow meter with wetted components (e.g., paddles, vanes, etc.) which are turned by the momentum of water moving through them. To interpret this motion (typically rotary), magnets are located within the wetted components and monitored by electronics associated with the flow meter. For carbonated water, however, this causes two issues. First, the wetted rotor and its associated local pressure gradients provide conditions which remove the carbon dioxide (CO2) from the carbonated water, thereby adversely affecting the carbonation level of the water and ultimate beverage. Second, the carbonated water is acidic, thereby leading to chemical compatibility issues with the wetted rotor and associated magnetic components which can deteriorate the rotor to the extent that the accuracy of the water flow measurement is compromised. It also bears noting that some of the products of reactions between the carbolic acid in carbonated water and some typical metals used for water contact in the flow mater are toxic, thereby posing a potential health hazard.

Improvements in carbonated water metering are therefore desired for producing chilled beverages which do not reduce the carbonation level of the beverage and remain accurate, reliable, and economical.

### SUMMARY OF THE INVENTION

The present disclosure provides such a water carbonation system which chills, dispenses, and meters carbonated water for use with a beverage machine in a manner which overcomes the foregoing deficiencies of the prior approaches used to prepare carbonated beverages. In one embodiment, the present system accurately meters the amount of carbonated water dispensed in a non-contact and simplified manner via pressure measurement alone. A processor-based programmable controller, which controls the dispensing operation of the beverage machine, correlates and calculates the volume of carbonated water dispensed by comparing the pressure drop of gas (i.e. CO2) in the carbonation system against at least one preprogrammed gas setpoint ratio associated with dispensing a desired specific volume of carbonated water selected by a user. A plurality of different setpoint ratios may be preprogrammed into the controller; each of which is associated with dispensing a respective different volume of carbonated water based on the preprogrammed beverage sizes the user selects via the user interface.

In use, for example, a user-operated control panel operably coupled to the controller allows the user to select a particular beverage cup size (e.g., 7 ounces, 9 ounces, 12 ounces, etc.), The cup sizes are each associated with a specific preprogrammed gas setpoint ratio, which in turn are each associated with a predetermined volume of carbonated water which will to be dispensed in order to fill the cup to a proper level based on the cup size preselected by the user. The volume of carbonated water dispensed may not necessarily represent the total volumetric capacity of the particular cup size used. Rather, the volume of carbonated dispensed may be mixed with amounts of other liquids such as still water, flavorants (e.g. instant powders or syrups), etc. to produce the final chilled beverage.

Advantageously, the present carbonation system operates in a manner which does not require precise metering or measuring of the amount of inert gas such as CO2 (i.e. moles of gas) initially needed to be added to the carbonation chamber such as via metered gas pumps, gas flow meters, or other gas measurement techniques. Instead, the carbonation chamber in the present embodiment is simply pressurized with CO2 from a gas source (such as a gas cylinder or other vessel) without use of a pump until the gas pressure in the chamber equilibrates and reaches the gas delivery pressure from the source. In the present system, the initial volume gas used to charge the carbonation chamber is unknown and unimportant.

The gas delivery pressure may be preselected and controlled by a pressure reducing device or devices, such as for example a gas pressure regulator or regulating valve fluidly coupled between the chamber and gas source. The regulator reduces the CO2 pressure from the source for use in the carbonation system. The present carbonated water metering system relies on the ratio of the measured actual real-time pressure in the carbonation chamber while vending or dispensing the carbonated water to the initial starting pressure of the gas in the chamber in order to determine when to terminate the carbonated water discharge for the beverage size selected by the user. Various suitable initial starting gas pressures in the carbonation chamber may therefore advantageously be used and are unimportant to metering the carbonated water volumes dispensed.

Because the carbonation chamber is sealed before the carbonated water vending or dispensing commences, there is a fixed volume contained in the carbonation chamber of the system which is comprised of a volume of water and a volume of CO2 which occupies the headspace above the surface level of the water in the chamber. As noted above, the volume of CO2 added to the carbonation chamber need not be known and is unimportant in the present carbonated water dispensing and metering scheme. When the dispensing valve is opened at the discharge from the carbonation chamber, the volume of CO2 expands in the chamber thereby decreasing the gas pressure in the carbonation chamber, and displacing a portion of the carbonated water which does not expand significantly as the compressibility of liquid is much lower than that of gas.

By monitoring the pressure of the chamber after dispensing via the controller with a pressure sensor operably coupled to the upper gas portion of the chamber, and using Boyle's gas law (P₁V₁=P₂V₂), the controller can automatically calculate the volumetric change of the CO2 gas relative to the preprogrammed gas setpoint ratios, and hence in turn the volume of carbonated water dispensed from the chamber as further described herein. A float or other level sensor controlled water pump maintains a constant level of water in the carbonation chamber before and after dispensing carbonated water. Therefore, the initial volume of gas in the chamber is always fixed by the free space above the water level, regardless of the initial pressure of the gas (CO2).

With prior knowledge of the starting gas volume fixed by the water level, which is determined via the initial system calibration and maintained by the water pump and associated liquid level sensor described previously, the actual volume of carbonated water dispensed can be controlled consistently by controller without intrusive interaction with the carbonated water such as via a wetted flow meter.

In one aspect, a method for preparing a carbonated beverage in a beverage machine comprises: providing a scalable carbonation chamber having a volumetric capacity, a gas source containing carbon dioxide at an initial gas source pressure, a still water source, and a programmable controller configured to implement steps including: monitoring a chamber gas pressure in the carbonation chamber; adding an amount of still water to the carbonation chamber to a first level; opening a gas control valve; flowing the insert gas from the gas source through a pressure reducing device, the pressure reducing device reducing the gas source pressure to a lower gas delivery pressure; pressurizing the carbonation chamber with the carbon dioxide to the gas delivery pressure to produce carbonated water; scaling the carbonation chamber; monitoring a real-time gas pressure in the carbonation chamber; a user selecting a beverage size on a control panel operably coupled to the controller; dispensing carbonated water from the carbonation chamber into a beverage cup of the user; and stopping the dispensing of carbonated water when the real-time gas pressure in the carbonation chamber drops to a value corresponding to a preprogrammed gas setpoint ratio calculated by the controller of the real-time gas pressure to the initial gas delivery pressure. The method may further include: pressuring the carbonation chamber a second time to a second gas delivery pressure different than the first gas delivery pressure; the same user or a different user selecting the same beverage size on the control panel; and stopping the dispensing of carbonated water when the real-time gas pressure in the carbonation chamber drops to a value corresponding to the same preprogrammed gas setpoint ratio calculated by the controller of the real-time gas pressure to the second gas delivery pressure. The preprogrammed gas setpoint ratio corresponds to the beverage size selected by the user. In one embodiment, the controller is preprogrammed with a plurality of preprogrammed gas setpoint ratios each corresponding to a different beverage size.

In another aspect, a carbonated beverage preparation system comprises: a head tank configured to hold still water; a cold block having a solid structure and comprising in thermal communication: a carbonation chamber formed in the cold block and containing an inventory of still water; a chilled water passageway formed in the cold block and fluidly coupled between the head tank and the carbonation chamber; a coolant passageway formed in the cold block and routed parallel to the chilled water passageway so as to transfer cold from coolant circulating through the coolant passageway to the chilled water passageway; a gas source containing carbon dioxide fluidly coupled to the carbonation chamber through a gas control valve, the gas control valve changeable between a closed position to isolate the gas source from the carbonation chamber, and an open position to pressurize the carbonation chamber; the carbonation chamber being pressurized with the carbon dioxide to produce carbonated water; a carbonated water discharge valve fluidly coupled to the carbonation chamber and an injection nozzle; and a product container supported by the beverage machine, the product container holding a flavorant; wherein upon opening the carbonated water discharge valve, carbonated water is dispensed from the carbonation chamber and injected through the product container to produce a carbonated beverage.

### BRIEF DESCRIPTION OF THE DRAWINGS

The features of the exemplary embodiments of the present invention will be described with reference to the following drawings, where like elements are labeled similarly, and in which:

FIG. 1 is a schematic system flow diagram of one embodiment of a carbonated beverage preparation system of a beverage machine according to the present disclosure which includes a reservoir-type water chiller;

FIG. 2 is schematic diagram of the beverage dispensing station of the carbonated beverage machine;

FIG. 3 is a flow chart showing the high level general steps in the method or process for preparing a carbonated beverage according to the present disclosure; and

FIG. 4 is a schematic system flow diagram of another embodiment of a carbonation carbonated beverage preparation system of a beverage machine according to the present disclosure which includes a flash-type water chiller.

All drawings are schematic and not necessarily to scale. Parts given a reference numerical designation in one figure may be considered to be the same parts where they appear in other figures without a numerical designation for brevity unless specifically labeled with a different part number and described herein. Any references to a whole figure number herein which may comprise multiple figures with the same whole number prefix but different alphabetical suffixes shall be construed to be a general reference to all those figures sharing the same whole number prefix, unless otherwise indicated.

### DETAILED DESCRIPTION OF THE EMBODIMENTS

The features and benefits of the invention are illustrated and described herein by reference to exemplary (“example”) embodiments. This description of exemplary embodiments is intended to be read in connection with the accompanying drawings, which are to be considered part of the entire written description. Accordingly, the disclosure expressly should not be limited to such exemplary embodiments illustrating some possible non-limiting combination of features that may exist alone or in other combinations of features.

In the description of embodiments disclosed herein, any reference to direction or orientation is merely intended for convenience of description and is not intended in any way to limit the scope of the present invention. Relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

As used throughout, any ranges disclosed herein are used as shorthand for describing each and every value that is within the range. Any value within the range can be selected as the terminus of the range. In addition, all references cited herein to prior patents or patent applications are hereby incorporated by reference in their entireties. In the event of a conflict in a definition in the present disclosure and that of a cited reference, the present disclosure controls.

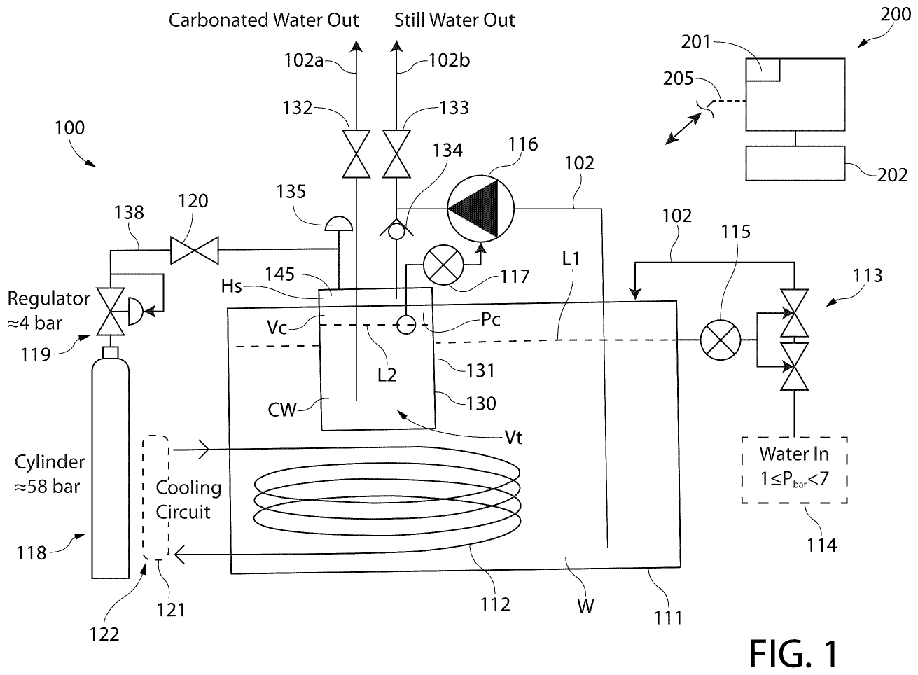

FIG. 1 is a schematic system flow diagram of a first embodiment of a carbonated beverage preparation system 100 configured to cool, carbonate, dispense, and meter/measure a volume of carbonated water dispensed for use in preparation of carbonated beverages in an associated carbonated beverage machine 101. The carbonation apparatus or portion of the system may be an integral part of the beverage machine, or a separate unit or module located adjacent and fluidly coupled to the machine, but not physically integrated inside the common housing of the machine. In one embodiment, the system 100 may be configured to also dispense a metered amount of still water either separately from and concurrently with dispensing carbonated water for preparation of carbonated drinks.

Referring initially to FIG. 1, the carbonated beverage preparation system 100 includes a reservoir type chiller comprising chilled water tank 111 which is filled with still water W by at least one water fill valve 113 fluidly coupled to a water source 114. Water source 114 may be any pressurized source of available potable water such as without limitation the main water supply system of a commercial, residential, or industrial building or facility. Other sources of water may be used. In some embodiments, the water source pressure may be ≥1 bar and <7 bar.

The water fill valve 113 is operably coupled to a level sensor 115 configured to detect a water level L1 in tank 111 which represents a level sensor setpoint. Any suitable commercially-available mechanical or electronic type water sensors may be used. In one embodiment level sensor 115 may be a float switch. The operable pairing of the combination fill valve 113 and level sensor 115 automatically controls filling the chamber 11 with water when the liquid level L1 drops below a preselected setpoint level into level sensor and/or the programmable microprocessor-based controller 200 associated with the beverage machine 101. When the water level drops below the preselected level, the normally closed fill valve 113 is opened via a signal from or mechanical linkage of the level sensor to add water to the tank and reestablish the original water level. This maintains a fixed level and volume of chilled still water in the chilled water tank. In some embodiments, a pair of fill valves 113 may be provided for fails-safe redundancy. If there was just one valve that failed open, then the chilled water tank 111 would be flooded and overflow.

The carbonated beverage preparation system includes a plurality of water flow conduits 102 configured as shown to fluidly interconnect the wetted fluidic components of the system together in the manner shown and described herein. Any suitable food-safe/food-grade metallic or non-metallic tubing (e.g., plastic) may be used to form the flow conduits 102 in one embodiment which are capable of handling the applicable temperature and pressure conditions encountered in various portions of the system. Accordingly, the flow conduits in various portions of the system may be formed of the same or different materials as needed to meet the required conditions.

Chilled water tank 111 is cooled by a cooling system 122 comprising a commercially-available cooling unit 121 and refrigerant or coolant coils 112 immersed in an inventory or body of still water W contained by the tank. The cooling unit circulates a suitable refrigerant or coolant through the coils in a closed flow loop to chill or cool the water in the tank to a preselected temperature representing the desired temperature of the carbonated beverage or drink to be dispensed by the beverage machine 101. In some embodiments, the coolant may be for example without limitation R134a, R290, R600, R600a, R127, or others.

Carbonated beverage preparation system 100 further includes a carbonation vessel or chamber 130 at least partially received inside the chilled water tank 111. The chamber contains a body of carbonated water CW which partially fills the chamber. Chamber 130 in turn is at least partially immersed in the water W in the tank below setpoint water level L1 so that the cooled water in the tank in turn cools the water inside the chamber which is under gas pressure. The carbonation chamber 130 comprises a hollow body or shell 131 made of a suitable food-safe/food-grade metallic material constructed to handle the temperature and pressurized conditions encountered in the chamber. The shell 131 may be cylindrical in one embodiment for the pressurized conditions (e.g., 4 bar or more).

The carbonation chamber 130 defines a fixed total volume Vt which is comprised of a volume of water and a volume of inert gas such as without limitation CO2. The upper portion of the chamber defines a headspace Hs which contains the gas and the lower portion the water. A water level L2 is defined at the interface between the gas and water. Accordingly, headspace Hs which holds the gas forms a headspace gas volume Vc which is defined between water level L2 at the surface of the water in the chamber 130 and the top of the chamber.

It bears noting that the carbonated water CW inside carbonation chamber 130 is fluidly isolated from the “still” (non-carbonated) water W within chilled water tank 111 within the tank itself. In other words, all portions of the carbonation chamber body or shell 131 are solid in structure without any openings that fluidly communicate with inventory of still water W in the chilled water tank. This prevents the water in the chilled water tank, which is at a lower pressure than the carbonated water CW in chamber 130, from being pressurized above the supply water pressure from the water source 114. The pressure inside chilled water tank 111 may therefore be less than the pressure inside the carbonation chamber 130.

Chilled water tank 111 in one embodiment is fluidly coupled to the carbonation chamber 130 external to the tank through water pump 116. The water pump takes suction from chilled water tank 111 and is fluidly coupled directly to the tank and carbonation chamber by flow conduits 102 as shown in FIG. 1. Water pump 116 is operable to pressurize the water W from tank 111, and in some embodiments both initially fill carbonation chamber 130 with still water from tank 111 and maintain water level L2 in the carbonation chamber via level sensor 117 operably coupled between the chamber and pump. Level L2 represents a setpoint level of level sensor 117. Similar in operation to level sensor 115 previously described herein, the carbonation chamber level sensor 117 is configured to detect level L2 and activates or deactivates the pump 116 to maintain the water level L2 in the carbonation chamber. In other words, pump 116 is automatically operated on/off by the level sensor 115. Level sensor 117 may be of a similar type as level sensor 115, or may be different.

Water pump 116 is configured and operable to elevate the pressure of the water from chilled water tank 111 to a pressure above the chamber gas pressure Pc inside carbonation chamber 130 (e.g., headspace Hs) in order to fill and periodically add the chilled still water to the chamber. Any suitable type of commercially-available water pump may be used.

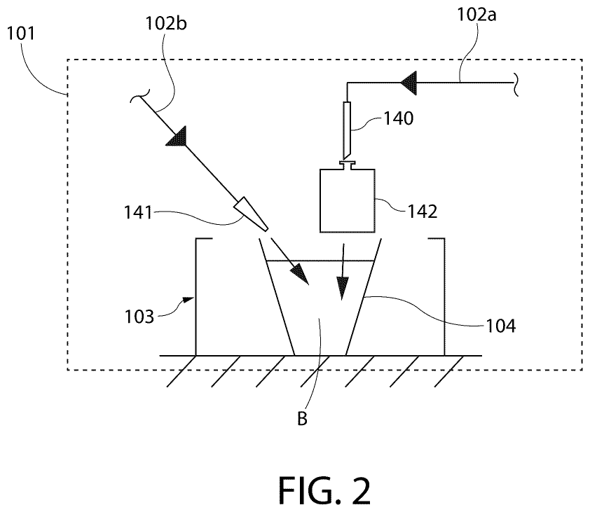

Water pump 116 is also dually operable to provide and dispense chilled/cooled still water from chilled water tank 111 directly to the beverage machine 101 for use in preparation of a beverage via an alternative flow path. With continuing reference to FIG. 1, the system 100 includes a still water discharge flow conduit 102b fluidly coupled at one end to carbonation chamber 130 and at an opposite end to a carbonated water injection nozzle 140 at the beverage dispensing station 103 of beverage machine 101 (see, e.g., FIG. 2). Beverage dispensing station 103 is configured to receive and support the user's beverage container such as cup 104 into which still water alone, or a mixture of still and carbonated water may be dispensed for beverage preparation. Still water discharge valve 133 located in discharge flow conduit 102b controls the amount of still water dispensed via open and closed positions of the valve under control of programmable controller 200 further described herein.

A branched connection is made between the discharge from water pump 116 and discharge flow conduit 102b. This allows the still water to flow into either carbonation chamber 130, or bypass the chamber and flow instead directly to the beverage machine 101 depending on the open or closed position of still water discharge valve 133. When discharge valve 133 is closed, still water may be pumped into the chamber 130 to initially fill the chamber during system setup, and thereafter to replenish the water supply in the chamber after each carbonated water dispensing cycle. When valve 133 conversely is open, the water is diverted from the carbonation chamber 130 and pumped in the flow path toward the beverage machine and still water dispensing nozzle 141 which sees atmospheric pressure and therefore is preferentially at a lower pressure than the chamber gas pressure Pc. Therefore, the flow automatically follows the path of least resistance to the beverage machine instead of the chamber. The higher gas pressure in carbonated water CW is prevented from entering the still water discharge flow conduit 102b via a one-way flow check valve 134 which only allows still water flow in one direction into the carbonation chamber.

The carbonated beverage preparation system 100 further includes the gas supply system which in the illustrated embodiment comprises pressurized gas source 118, a gas pressure reduction station including a pressure reducing device(s) such as without limitation a gas regulator valve 119, and gas control valve 120 shown in FIG. 1. Gas source 118 is fluidly coupled to carbonation chamber 130 via gas conduit 138 through the regulator valve and control valve. Pressure sensor 135 senses the gas pressure downstream of the control valve in carbonation chamber 130. Gas control valve is changeable between open and closed positions to either permit gas to fill the carbonation chamber 130 from gas source 118, or fluidly isolate the chamber from the source.

The gas may be CO2 in the non-limiting preferred embodiment for producing chilled carbonated beverages. Any suitable type of gas source and supply pressure may be used. In one embodiment, a gas tank or cylinder 118a of suitable capacity may be used as shown. The gas supply pressure may be about 58 bar in one embodiment; however, other pressures may be used.

Gas regulator valve 119 (which may alternatively be referred to herein as simply a gas regulator for brevity) is configured with a setpoint pressure to reduce the pressure of the gas from the gas source 118 to the lower setpoint pressure which represents a gas delivery pressure. The lower pressure gas delivered by gas regulator fills the carbonation chamber 130 which is pressurized to the gas delivery pressure. As one non-limiting representative example, the gas source pressure of a CO2 cylinder type gas source may be about 58 bar and the pressure regulator setpoint pressure may be about 4 bar. Other suitable source pressures and setpoint pressures may be used. Any suitable commercially-available gas pressure regulator may be used.

In some embodiments, the gas regulator valve 119 may be omitted and the gas control valve 120 may be equipped with a variable flow throttling valve trim allowing the valve to be opened at intermediate positions between fully open and fully closed. In this case, gas control valve 120 is operably coupled to pressure sensor 135 which measures the actual real-time gas pressure in carbonation chamber 130. With a throttling gas control valve 120, the valve may still be operated in the fully closed position once the carbonation chamber is pressurized to the gas delivery pressure controlled by the gas control valve. Either pressure reduction scenario and equipment described above may be used in the present carbonation system. In yet other alternative embodiments, the CO2 gas source pressure need not be reduced if the source pressure is suitably low as to not exceed the maximum pressure design limits of the carbonation system equipment. In this case, gas control valve 120 alone may be used in the fully open position to pressurize fill carbonation chamber 130 with gas initially, and the fully closed position to isolate the gas source from the chamber.

On the carbonated water dispensing side, the carbonated beverage preparation system 100 further includes a carbonated water discharge valve 132 which is fluidly coupled to carbonation chamber 130 and injection nozzle 140 of the beverage machine 101 via carbonated water discharge flow conduit 102a. The proximal end of flow conduit 102a is immersed in the body of carbonated water CW in carbonation chamber 130 below water level L2 to draw and ensure only the carbonated water is driven out of the chamber by the CO2 gas pressure Pc in the chamber. The distal end of flow conduit 102a is fluidly coupled to injection nozzle 140.

Injection nozzle 140 may be selectively fluidly coupled to a disposable single-use sealed product container 142 supported by beverage machine 101 at beverage dispensing station 103. The nozzle is configured and operable to inject the carbonated water through the product container when preparing a carbonated beverage. The product container 142 may be any suitable type in configurations such as rigid or flexible sachets, packets, capsules pouches, cups, pods, or similar which hold the flavored beverage substance (e.g., flavorant) for producing various different carbonated beverages based on the type of flavorant used. The beverage substance may be in liquid, granular or powdered form as some non-limiting examples. The distal end of nozzle 140 may be configured to pierce the product container when loaded into the beverage machine 101 by the user. After the beverage is prepared, the product container 142 is disposed.

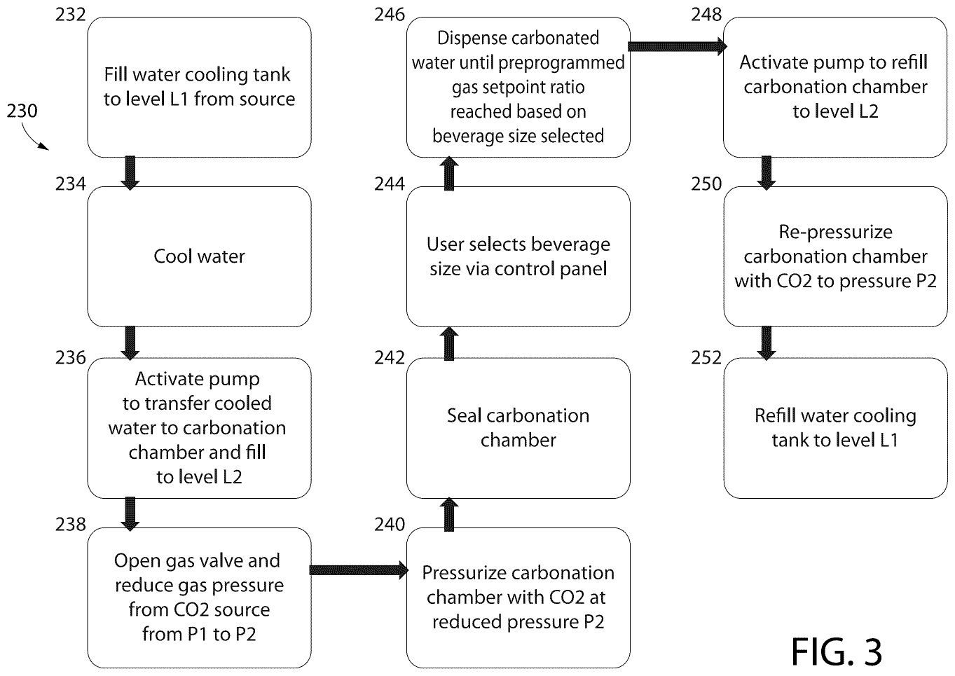

The beverage machine 101 includes a programmable system controller 200 which is operably coupled to the carbonation systems 100, 300 and the components shown respectively in FIGS. 1 and 3 via suitable wired and/or wireless communication links 205. For example, referring to FIG. 1, controller 200 is configured via programming with appropriate software instructions to control operation of the carbonation system and its components, which may include for example without limitation in various embodiments maintaining the water levels L1, L2 in the chilled water tank 111 and carbonation chamber 130 via level sensors 115 and 117, operating the gas and water valves described herein including valves 113, 119, 120, 132, 133, and 134, sensing gas pressure inside carbonation chamber 130 via pressure sensor 135, cooling unit 121, and water pump 116. Controller 200 may therefore be operably coupled to level sensors 115, 117 to receive data from the sensors about water levels L1 and L2.

The controller 200 is operably coupled and linked to a user-accessible electronic control panel 202 which may be onboard the beverage machine 101. The control panel provides an input device which allows the user to initiate the actions of the brewing machine for brewing the beverage and frothing the milk. Panel 202 may include a touchscreen in some embodiments and includes the usual appurtenances for user programming and interface purposes such as hard and/or soft buttons, status/indicator lights, etc. “Hard” buttons connote physical buttons, whereas “soft” buttons connote software-generated buttons displayed on the control panel screen by the controller. Any suitable commercially-sourced type of control panel or display may be used.

The programmable controller 200 may include one or more microprocessors or processors, a system on a chip (integrated circuit), or combinations thereof which execute the program or software instructions (e.g., control logic) that control operations of the beverage machine 101 and cause the carbonated beverage preparation system 100 to perform the operations and methods disclosed herein associated with preparation of the final carbonated beverage.

Controller 200 includes non-transitory tangible computer or machine accessible and readable medium such as memory 201 on which the software and various system setpoints or baseline parameters (e.g., temperatures, pressures, etc.) described herein are stored and accessed by the microprocessor(s). Memory 201 of the machine readable medium may include any suitable volatile memory and non-volatile memory or devices operably and communicably coupled to the microprocessor(s). Any suitable combination and types of volatile or non-volatile memory may be used including as examples, without limitation, random access memory (RAM) and various types thereof, read-only memory (ROM) and various types thereof, hard disks, solid-state drives, flash memory, or other memory and devices which may be written to and/or read by the processor operably connected to the medium. Both the volatile memory and the non-volatile memory may be used for storing the program instructions or software.

Controller 200 includes all other electronic devices/components, peripherals, appurtenances, power management system, communication interfaces (hard wired and/or wireless connections), etc. not mentioned herein for the sake of brevity which are customarily supplied with a controller to provide a fully functional control system.

A method or process 200 for preparing a carbonated beverage using the carbonation system 100 with beverage machine 101 previously described herein will now be summarized. Reference to hardware is made to FIGS. 1 and 2, and the foregoing discussion of the components shown therein. FIG. 3 provides an overview of the major high-level steps in the process or method referenced below, with further details of each step discussed as necessary. The various actions described below and operation of the carbonation system and its components may be initiated and implemented by the system controller 200 alone or in part unless otherwise noted.

To initially set up the system for carbonating and then dispensing the water, gas control valve 120, discharge valves 132, 133, and water fill valve 113 are closed. Water pump 116 is off. Chilled water tank 111 is first filled with still water W from water source 114 by opening fill valve 113 until level L1 is reached (Step 232). Controller 200 may implement this step, or alternatively the combination water level sensor 115 and fill valve 113 may autonomously fill the tank and maintain level L1 independently of controller control. The water in tank 111 is cooled by activating the cooling system 122 to circulate coolant through the wetted coolant coils 112 in direct contact with the water in the tank (Step 234).

In Step 236, water pump 116 is activated by controller 200 to pump chilled/cooled water from tank 111 into carbonation chamber 130. Pump 116 continues to operate until the water level reaches level L2, and is then stopped via level sensor 117 in the manner previously described herein for controlling the level of carbonated water WC in chamber 130.

In Step 238, gas control valve 120 is opened and the gas (CO2) from gas source 118 (e.g., CO2 cylinder) is reduced in pressure from the bottled initial gas source pressure P1 to a second lower dispensed gas pressure P2 as it flows through gas regulator valve 119 to carbonation chamber 130. P2 may be considered the gas delivery pressure available to the carbonation chamber. The gas source is now in fluid communication with the carbonation chamber 130.

In Step 240, the upper portion or headspace Hs in carbonation chamber above water level L2 is pressurized and filled with CO2 at the lower dispensed gas pressure P2 until the gas pressures at the outlet of gas regulator valve 119 and the headspace Hs are equilibrated (i.e. gas pressure Pc in carbonation chamber reaches reduced pressure P2). This automatically and rapidly occurs when gas control valve 120 is opened.

In Step 242, the carbonation chamber 130 is fluidly sealed by closing gas control valve 120. This creates a sealed total volume Vt of the carbonation chamber 130 (water and gas portions) which is known as well as concomitantly the smaller volume Ve of the headspace Hs in the upper portion of the chamber which is defined above the water level L2 and automatically maintained by water pump 116 via level sensor 117. Volume Ve therefore remains a known fixed and smaller volume of the chamber before dispensing carbonated water. Controller 200 may measure (via pressure sensor 135) and confirm that the gas pressure Pc in chamber headspace Hs after closing gas control valve 120 is equal to lower gas dispensing pressure P2. The system is now readied for dispensing carbonated water.

In Step 244, the user selects the desired beverage cup size on the beverage machine control panel 202. The controller 200 receives the selection and determines the appropriate preprogrammed gas setpoint ratio corresponding to the beverage size selected. The controller then opens carbonated water discharge valve 132 to dispense the carbonated water CW from the carbonation chamber 130 (Step 246). The carbonated water flows through carbonated water discharge flow conduit 102a to and is dispensed from nozzle 140 through product container 142 and thereafter into the user's cup 104 positioned by the user in the beverage dispensing station 103 of beverage machine 101. The carbonated water mixes with the flavorant in the product container to generate the flavored carbonated beverage which is dispensed into the user's cup.

Once the user has initially selected the beverage cup size previously as described above, the controller 200 continues to monitor the actual real-time gas pressure Pc in carbonation chamber 130 via pressure sensor 135. Carbonated water discharge valve 132 remains open until the controller determines that the preprogrammed gas setpoint ratio has been reached by measuring and monitoring the headspace chamber gas pressure Pc in chamber 130 which drops as carbonated water is dispensing. Reaching the setpoint ratio indicates to the controller that the desired volume of carbonated water associated with the user-selected beverage size has been dispensed based the preprogrammed setpoint ratio values regardless of the initial starting chamber pressure Pc and final chamber pressure values. The gas volume in carbonation chamber 130 increases with the displacement of carbonated water from the chamber, thereby decreasing the gas pressure according to the Boyle's gas law previously described herein. As previously described herein, the preprogrammed gas setpoint ratio may be one of several preprogrammed setpoint ratios each associated with dispensing a different volume of carbonated water for a respective different size user beverage cup 104.

Once the setpoint ratio is reached, the controller closes carbonated water discharge valve 132 to stop dispensing carbonated water since the controller knows that the correct volume of water has been dispensed.

In Step 248 after discharge valve 132 is closed, the controller activates water pump 116 to refill the water in the carbonation chamber 130 to level L2. Water pump 116 is then deactivated. Controller 200 next opens gas control valve 120 again to re-pressurize the chamber 130 with CO2 to the dispensed gas pressure P2 as previously described herein (Step 250). In Step 252, water fill valve 130 may be opened based on the water level detected by level sensor 115 in chilled water tank 111 to refill the tank to starting chilled water level L1. The carbonation system 100 is therefore primed to begin the next carbonated water dispensing cycle by repeating the foregoing steps.

In certain types of beverage preparation, it may be desirable to either mix carbonated and still water in a single beverage, or to dispense still water alone for an uncarbonated beverage. This may be initiated by the user selecting appropriate hard or soft buttons on control panel 202. In the former case, still water may be added to the user's cup 104 either before, after, or simultaneously with dispensing carbonated from chamber 130. To dispense the still water, controller 200 opens still water discharge valve 133 and then activates the water pump 116. Since the injection nozzle 140 sees atmospheric pressure, the pumped water will flow towards and be discharged from the nozzle instead of flowing towards the carbonation chamber 130. The length of time that the still water is pumped and amount (volume) thereof may be based on the cup size selected by the user at control panel 202. This ensures that the cup is not overfilled or under filled.

It bears noting that the foregoing process or method for dispensing and metering a volume of carbonated water for beverage preparation does not rely on knowing or quantifying the amount of CO2 (i.e. moles of gas) initially added to the carbonation chamber 130. The controller 200 functions on the principle of preprogrammed gas setpoint ratios of the actual real-time pressure Pc measured in the carbonation chamber as carbonated water is dispensing to the starting/initial gas pressure Pc in the chamber (i.e. gas delivery pressure P2); each setpoint ratio being associated with a respective preprogrammed beverage size selected by the user to prepare the chilled beverage. The dispensing of chilled carbonated water is stopped when the controller 200 determines that the setpoint ratio has been reached based on monitoring the real-time pressure Pc in the carbonation chamber. Advantageously, because the system relies on preprogrammed gas setpoint ratios corresponding to pressure drop and not actual pressure values measured in the carbonation chamber, the carbonation system will function properly regardless of the starting or initial pressure in the carbonation chamber 130.

The present carbonation system advantageously offers a reliable process for creating a chilled carbonated beverage with minimal equipment cost and complexity. On the gas side of carbonation system, the CO2 simply flow directly from the gas cylinder through the gas regulator pressure reduction station to the carbonation chamber unassisted by expensive gas pumps or gas flow meters for measuring moles of gas added to the carbonation chamber.

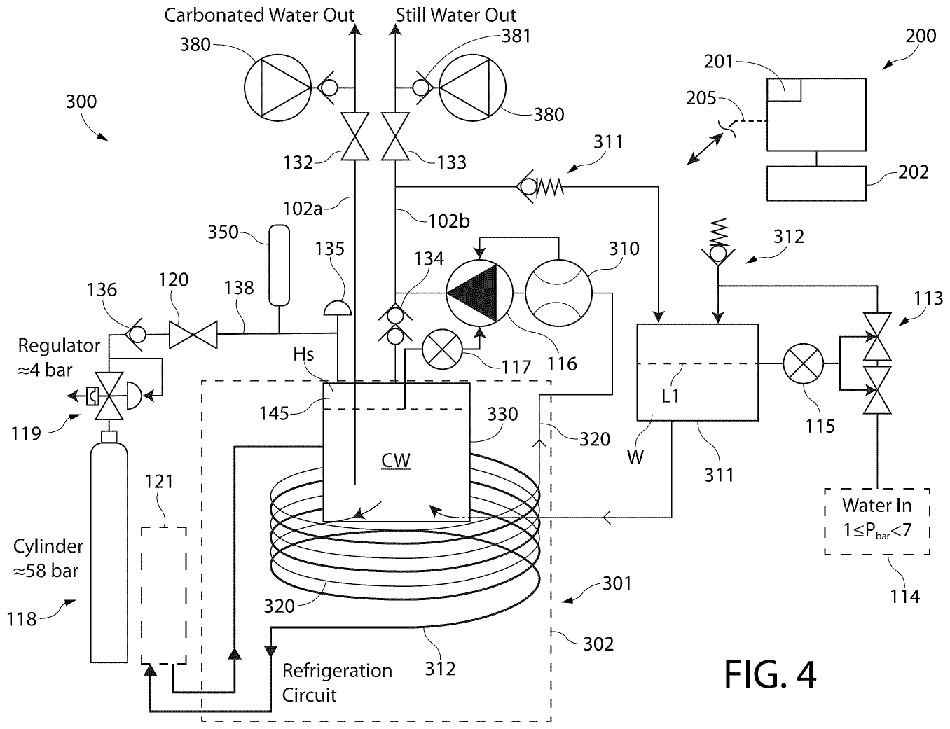

FIG. 4 depicts an alternative embodiment of a carbonated beverage preparation system 300 associated with the beverage machine 101 for preparation of chilled carbonated beverages. Operation of the present system 300 and method for preparing a carbonated beverage previously described herein is essentially the same in all key aspects and will not be repeated here for the sake of brevity. A few equipment alternations and substitutions however are made in the present system, as follows.

In the present embodiment of carbonated beverage preparation system 300, the reservoir type chiller of carbonation system 100 previously described herein using chilled water tank 111 holding a body or inventory of chilled still water in which cooling coils 112 are immersed as a source of chilled still water is replaced by a flow-through flash chiller 301. Advantageously, this fast-acting chiller is more compact, thereby reducing the chiller and carbonation system space requirements resulting in a smaller carbonated beverage machine 101. In addition, the large reservoir of chilled water (i.e. chilled water tank 111) is eliminated, which saves energy consumption and associated costs with maintaining the cooled reservoir. The present flash chiller functions on an “on demand” basis. Other aspects of the beverage machine however including the beverage dispensing station 103 and associated carbonated water injection nozzle 140 and still water dispensing nozzle 141 remain the same.

Referring to FIG. 4, flash chiller 301 generally comprises a cast, molded, or otherwise formed solid metal cold block 302 in structure in which a coolant passageway 312, chilled (still) water passageway 320, and carbonation chamber 330 are integrally formed as recessed negative features (i.e. openings or voids) in the cold block. These features shown within the dashed physical boundary lines of cold block 302 in FIG. 4 are located within the cold block. Any suitable polygonal or non-polygonal shaped metallic block may be used. Any metal having a suitable thermal conductivity to quickly and efficiently transfer cold from the refrigerant/coolant circulating through the coolant passageway 312 in the block to the chilled water passageway 320 and carbonation chamber 330 may be used. In one non-limiting embodiment, the cold block may be formed of cast aluminum for example.

Coolant and chilled water passageways 312, 320 may each be helical in configuration and form parallel circuitous paths through cold block 302 in close proximity to each other for heat transfer (i.e. cold from the coolant to the still water circulating in the chilled water passageways). The passageways 312, 320 may be wound around the carbonation chamber 330 inside the passageways in cold block 302. The cold is transferred radially inwards to the carbonation chamber. Carbonation chamber 330 may be a cylindrical shaped recess or void in the cold block in one embodiment. The passageways 312, 320 and carbonation chamber 330 are all fluidly isolated from each other inside the cold block.

In the present embodiment of carbonation system 300, a still water head tank 311 is provided upstream of the cold block 302 between the water source 114 and carbonation chamber 330 inside the cold block. Level sensor 115 and water fill valve(s) 113 in the present embodiment control the water level L1 and maintain the inventory of still water W in head tank 311 in lieu of that in the chilled water tank 111 in the first embodiment shown in FIG. 1 and described above. The function and operation of the level sensor and fill valve(s) is otherwise the same.

To fill and maintain a level of chilled water CW in carbonation chamber 330 in the present embodiment, water pump 116 draws water from head tank 311 through the cold block 302. The water is rapidly cooled as it flows through the helical chilled water passageway 302 in the block and then is pumped into carbonation chamber 330.

The same alternate flow path for pumping chilled uncarbonated water through still water dispensing nozzle 141 into the user's beverage cup 104 at the beverage dispensing station 103 of beverage machine 101 is retained in the present system 300. To dispense still water alone, a flow meter 310 may optionally be provided in the chilled water flow path between cold block 302 and water pump 116 to measure the amount chilled water pumped when demanded. Flow meter 310 is operably and communicably linked to system controller 200 which measures the amount of chilled still water dispensed. The controller may automatically control the amount of still water dispensed based on the cup size selected by the user and input into control panel 202 previously described herein, or the user may manually control the amount of still water added to the cup via hard or soft (i.e. software) buttons on the control panel.

To increase the volumetric capacity of the carbonation chamber 330 of cold block 302, an optional supplementary gas reservoir 350 may be provided as shown in FIG. 3. Gas reservoir 350 which may be a metallic vessel such as a tank may be fluidly coupled to gas conduit 138 between carbonation chamber 330 and gas control valve 120. In other embodiments, the gas reservoir 350 may be fluidly coupled directly to the gas-filled headspace Hs in the upper portion of the carbonation chamber 330. In operation, the CO2 gas pressurizes the headspace Hs inside chamber 330, reservoir 350, and section of gas conduit 138 downstream of gas control valve 120 and the chamber to the same pressure (e.g., 4 bar or other). The effective total volumetric capacity of CO2 for carbonating the chilled water stored in carbonation chamber 330 is therefore the sum of volumetric capacity of each of these foregoing pressure retention components.

The addition of the supplementary gas reservoir 350 provides advantages. First, the added gas volume of gas reservoir 350 allows the carbonation chamber 330 and concomitantly cold block 302 to be smaller, thereby reducing the size of the cold block and associated fabrication costs. It is also easier to find available space inside beverage machine 101 for the reservoir than a larger cold block since the reservoir need only fluidly coupled to the carbonation chamber 330 in the block. This means that any available space inside the beverage machine 101 may be utilized for locating the reservoir 350. In addition, the increased gas volume capacity (i.e. CO2) provided by the gas reservoir 350 causes less reduction in the volume of CO2 in headspace Hs lost when carbonated water CW is dispensed. This creates more “fizz” in the carbonated water dispensed since there is a smaller drop in the carbonation level of the water when it carbonated water is dispensed each time. Other embodiments however may omit the gas reservoir 350 and opt for a larger carbonation chamber 330 in cold block 302.

The present carbonated beverage preparation system 300 being discussed shows the addition of a pair of air pumps 380; one for the carbonated water discharge flow conduit 102a and one still water discharge flow conduit 102b. Each air pump is located downstream of its respective carbonated or still water discharge valve 132 or 133 as shown. Flow of still or carbonated water from the discharged flow conduits back into the pumps is prevent by one-way flow air check valves 381. The air pumps 380 are used to blow out the carbonated water discharge flow conduit 102a and still water discharge flow conduit 102b after each carbonated beverage or still water dispensing cycle to ensure there is no residual water left in the flow conduits for the next dispensing cycle.

As will be readily apparent from the discuss above, numerous equipment and operating scenarios are possible using the various embodiments of the beverage preparation system disclosed herein to heat and froth the supplementary liquid and brew the beverage.

While the foregoing description and drawings represent exemplary (“example”) embodiments of the present disclosure, it will be understood that various additions, modifications and substitutions may be made therein without departing from the spirit and scope and range of equivalents of the accompanying claims. In particular, it will be clear to those skilled in the art that the present invention may be embodied in other forms, structures, arrangements, proportions, sizes, and with other elements, materials, and components, without departing from the spirit or essential characteristics thereof. In addition, numerous variations in the methods/processes described herein may be made within the scope of the present disclosure. One skilled in the art will further appreciate that the embodiments may be used with many modifications of structure, arrangement, proportions, sizes, materials, and components and otherwise, used in the practice of the disclosure, which are particularly adapted to specific environments and operative requirements without departing from the principles described herein. The presently disclosed embodiments are therefore to be considered in all respects as illustrative and not restrictive. The appended claims should be construed broadly, to include other variants and embodiments of the disclosure, which may be made by those skilled in the art without departing from the scope and range of equivalents.

What is claimed is:

1. A method for preparing a carbonated beverage in a beverage machine, the method comprising:
providing a sealable carbonation chamber having a volumetric capacity, a gas source containing carbon dioxide at an initial gas source pressure, a still water source, and a programmable controller configured to implement steps including:
monitoring a chamber gas pressure in the carbonation chamber;
adding an amount of still water to the carbonation chamber to a first level;
opening a gas control valve;
flowing the insert gas from the gas source through a pressure reducing device, the pressure reducing device reducing the gas source pressure to a lower gas delivery pressure;
pressurizing the carbonation chamber with the carbon dioxide to the gas delivery pressure to produce carbonated water;
sealing the carbonation chamber;
monitoring a real-time gas pressure in the carbonation chamber;
a user selecting a beverage size on a control panel operably coupled to the controller;
dispensing carbonated water from the carbonation chamber into a beverage cup of the user; and
stopping the dispensing of carbonated water when the real-time gas pressure in the carbonation chamber drops to a value corresponding to a preprogrammed gas setpoint ratio calculated by the controller of the real-time gas pressure to the initial gas delivery pressure.

2. The method according to claim 1, wherein the preprogrammed gas setpoint ratio corresponds to the beverage size selected by the user.

3. The method according to claim 1 or 2, wherein the controller is preprogrammed with a plurality of preprogrammed gas setpoint ratios each corresponding to a different beverage size.

4. The method according to any one of claims 1 to 3, further comprising maintaining the first level of still water in the carbonation chamber after dispensing the carbonated water by selectively operating a water pump fluidly coupled between the still water source and the carbonation chamber to add still water to the carbonation chamber when a level of still water in the carbonation chamber drops below the first level.

5. The method according to claim 4, wherein the water pump is controlled by a level sensor configured to monitor the first level of the still water in the carbonation chamber, the level sensor activating the water pump when a level of the still water in the carbonation chamber drops below the first level.

6. The method according to claim 4 or 5, further comprising before or after the step of dispensing the carbonated water, operating the water pump to pump still water from the still water source into the beverage cup.

7. The method according to claim 6, further comprising opening a still water discharge valve fluidly coupled to the water pump before operating the water pump.

8. The method according to claim 7, wherein the still water discharge valve is closed when the water pump adds still water to the carbonation chamber.

9. The method according to any one of claims 1 to 8, wherein the still water source comprises a chilled water tank holding a body of the still water, and further comprising circulating a coolant through the body of still water to chill the water.

10. The method according to claim 9, wherein the carbonation chamber is at least partially immersed in the body of still water in the chilled water tank to keep the water in the carbonation chamber cooled.

11. The method according to any one of claims 4 to 8, wherein the still water source comprises a cold block comprising parallel and fluidly isolated coolant and still water passageways formed therein, and further comprising circulating a coolant through the coolant passageway which in turn chills the still water.

12. The method according to claim 11, further comprising the still water passageway drawing water from a head tank containing still water, and circulating the still water via the water pump through the still water passageway to the carbonation chamber.

13. The method according to any one of claims 1 to 12, further comprising the controller monitoring gas pressure in the carbonation chamber via a pressure sensor operably coupled to the carbonation chamber.

14. The method according to claim 13, wherein the pressure reducing device is a gas regulator valve coupled to the pressure sensor which measures a pressure of the gas in the carbonation chamber.

15. The method according to any one of claims 1 to 14, wherein the dispensing step includes passing the carbonated water through a product container containing a flavorant to produce a flavored carbonated beverage.

16. The method according to claim 1, wherein moles of the carbon dioxide in the carbonation chamber is unknown when the carbonation chamber is first pressurized and the carbonated is dispensed.

17. The method according to claim 1, wherein the pressurizing step includes pressurizing a supplementary gas reservoir simultaneously with pressurizing the carbonation chamber, the supplementary gas reservoir being in fluid communication with the carbonation chamber.

18. The method according to claim 1, further comprising:
pressuring the carbonation chamber a second time to a second gas delivery pressure different than the first gas delivery pressure;
the same user or a different user selecting the same beverage size on the control panel; and
stopping the dispensing of carbonated water when the real-time gas pressure in the carbonation chamber drops to a value corresponding to the same preprogrammed gas setpoint ratio calculated by the controller of the real-time gas pressure to the second gas delivery pressure.

19. A carbonated beverage preparation system comprising:
a head tank configured to hold still water;
a cold block having a solid structure and comprising in thermal communication:
a carbonation chamber formed in the cold block and containing an inventory of still water;
a chilled water passageway formed in the cold block and fluidly coupled between the head tank and the carbonation chamber;
a coolant passageway formed in the cold block and routed parallel to the chilled water passageway so as to transfer cold from coolant circulating through the coolant passageway to the chilled water passageway;
a gas source containing carbon dioxide fluidly coupled to the carbonation chamber through a gas control valve, the gas control valve changeable between a closed position to isolate the gas source from the carbonation chamber, and an open position to pressurize the carbonation chamber;
the carbonation chamber being pressurized with the carbon dioxide to produce carbonated water;
a carbonated water discharge valve fluidly coupled to the carbonation chamber and an injection nozzle; and
a product container supported by the beverage machine, the product container holding a flavorant;
wherein upon opening the carbonated water discharge valve, carbonated water is dispensed from the carbonation chamber and injected through the product container to produce a carbonated beverage.

20. The system according to claim 19, further comprising a pressure reducing valve, the pressure reducing valve configured to reduce the carbon dioxide from the gas source pressure to a lower gas delivery pressure, the carbonation chamber being pressurized with carbon dioxide at the gas delivery pressure.

21. The system according to claim 20, wherein the carbonated beverage is dispensed into a beverage cup of a user disposed below the product container in the beverage machine.

22. The system according to any one of claims 19 to 21, further comprising a water pump configured and operable to draw still water from the head tank through the chilled water passageway in the cold block which chills the still water, and then pump the still water into the carbonation chamber.

23. The system according to claim 22, wherein the water pump is selectively activated to pump still water into the carbonation chamber via a level sensor configured to detect and maintain a level of the still water in the carbonation chamber.

24. The system according to claim 22 or 23, wherein the water pump is further configured to pump the still water in an alternate flow path which bypasses the carbonation chamber and flows through a still water discharge valve.

25. The system according to any one of claims 19 to 24, wherein the coolant and chilled water passageway comprise helical sections which are wound around the carbonation chamber in the cold block.

26. The system according to any one of claims 19 to 25, wherein the cold block is formed of a metallic material.

27. The system according to claim 20, further comprising a supplementary gas reservoir fluidly coupled to a headspace in an upper portion of the carbonation chamber formed above the still water which holds the carbon dioxide, the supplementary gas reservoir increasing a volumetric capacity of the headspace for holding the carbon dioxide.

28. The system according to any one of claims 21 to 26, further comprising a pressure reducing valve fluidly interposed between the gas control valve and gas source, the pressure reducing valve being configured to reduce the carbon dioxide from a gas source pressure to a lower gas delivery pressure, the carbon dioxide in the carbonation chamber being at the gas delivery pressure.

29. The system according to claim 28, further comprising a pressure sensor operable to measure gas pressure in the carbonation chamber.

30. The system according to claim 19, further comprising a programmable controller configured to initiate dispensing of carbonated water and terminate the same when a preprogrammed gas setpoint ratio is reached based on real-time gas pressure measured by a pressure sensor operably coupled to the controller and the carbonation chamber.
